(19) United States
(12) Patent Application Publication
(10) Pub. No.: US 2006/0031347 A1
(43) Pub. Date: Feb. 9, 2006

(54) Corporate email system

(75) Inventor: Pekka Sahi, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Pekka Sahi

(21) Appl. No.: 11/083,745

(22) Filed: Mar. 17, 2005

Related U.S. Application Data
(60) Provisional application No. 60/580,859, filed on Jun. 17, 2004.

(51) Int. Cl. G06F 15/16; G06F 17/30

(52) U.S. Cl. 709/206; 707/200

(57) ABSTRACT

An email server (11a) configured to store a template folder structure (11c) and template action rules (11b) for use by an email client (12a) in creating a folder structure (12b) and action rules (12c).

### CROSS REFERENCE TO RELATED APPLICATION

Reference is made to and priority claimed from U.S. provisional application Ser. No. 60/580,859 filed 17 Jun. 2004, entitled CORPORATE EMAIL SYSTEM.

### TECHNICAL FIELD

The present invention pertains to the field of email. More particularly, the present invention pertains to routing email intended for either members of a corporation (or any other form of organization) or for higher-level groupings of members of the organization, such as a department or a task force, or even for the corporation generally.

### BACKGROUND ART

In a business organization today, a typical employee may waste significant time managing email, and in particular, archiving received email into an appropriate folder on the employee's email terminal and looking for a particular email from the archive folders. Email on the Internet is described in various Internet Engineering Task Force (IETF) Request for Comments (RFC) documents, including: RFC 2821, RFC 1939 and RFC 3501.

The prior art provides some relief. The employee can, to some extent, automate the above tasks by first building up his or her own email archive system and then using what are here called “action rules” (and sometimes called simply “message rules” by the prior art) that provide instructions to the employee's email client as to how to respond to a received email—e.g. to archive it in a specified folder, i.e. other than what is typically indicated as an Inbox—depending on text included in the body or header of the email.

What the prior art does not provide, however, is an organizational level solution for harmonizing the employees' email archive structures and action rules. Therefore, currently, each individual employee must develop their own email archive folders and action rules, and some employees are more capable than others of doing so. Some employees may lack the time, tolerance or know-how to do so, in which case their time may be wasted on handling the unorganized mass of emails. Further, even if all employees are reasonably able to do so, the archive folder structure and action rules of one employee may differ substantially from those developed independently by another employee.

Thus, what is needed is a way of having each employee have substantially the same email archive folder structure and action rules as every other employee. This would considerably reduce the time spent by employees on managing email: the individual's time spent on going through received emails and building up the archive system would be reduced, as well as time spent looking for wanted emails. This would also considerably ease up communication and tasks within an organization as common information would be found in common folders, not in user-defined folders anymore. The closer the job descriptions and sub-organizations of two employees are, the more similar their folder structures and action rules should be. On the other hand, the more there are differences in the job descriptions and sub-organizations, the more differences there can be in the folder structures and action rules.

Another issue is that in some computing platforms running an email client, e.g. in mobile phones, internal storage space and the bandwidth used for communication may be more limited than for other platforms, e.g. in desktop terminals with an Ethernet connection. This causes longer email download times and memory shortages on the more limited platforms, thereby degrading the email user experience.

The prior art provides email clients for which the user can, to some extent, define what emails to download and what not to download, based e.g. on information about the sender included in the email or based on the size of the email. Some systems allow a user to define beforehand and for each email what to receive—header or body or just a notification that an email has arrived—again based on some detail of (information included with or characteristic of) the email. The user can have different settings on different email clients, resulting in e.g. the same email being delivered from an email server in whole in case of delivery to a less limited platform and only partially in case of delivery of the same email to a more limited platform (e.g. the mobile phone).

What the prior art does not provide, however, is a way for the email system itself to be made aware of the characteristics of the email client host hardware, characteristics such as memory and bandwidth. Therefore, these characteristics cannot currently be used by the email system as an input to an action rule.

Thus, what is also needed is a way having an email system know of possible platform/hardware limitations of an email client when an email is being matched against an action rule. This would enable the creation of platform-dependent action rules that would improve the email user experience on a more limited platform. The possible platform limitations could also be used as an input to the harmonized action rules of an organization, described above. All that would likely speed up the adoption of email as an application in mobile handsets, as the user experience would be improved by not wasting bandwidth and memory resources to lower prioritized emails, and by shifting the trouble of making this happen in practice to e.g. system administrators of the organization responsible for the harmonized action rules.

Yet another background issue is the protection against emails contaminated by malicious viruses. Viruses cannot infect email messages; instead they are carried and spread through attachments such as document or program files. The prior art provides protective client software that scans email attachment files for viruses as part of scheduled or forced scans or when an email document to which they are attached to is opened for reading. The prior art also provides the means for this scanning to be achieved in the network, i.e. prior to the email being routed to the client. Scanning uses a virus definitions file that contains a list of known virus patterns or signatures; if a match is found, the scanned file is infected. After a virus is found in an attachment, an attempt to clean, quarantine, leave alone, or delete the attachment is made.

What the prior art does not provide in respect to virus protection is an automated means of protection for the end user against an email virus infecting an email attachment before a virus definitions file incorporating its pattern or signature is in place. If the known pattern or signature of the virus is not found in the definitions file (e.g. because the virus is newer than the virus definitions file), the scanning will not reveal the virus that may thus harm the computer.

Therefore, what is also needed is a way of having an email system discover a virus as soon as its patterns have become known but even before the patterns have been incorporated into the virus definition file in use by the email system. When a totally new virus is found, it is first analyzed for common patterns and signatures. Incorporating these into a working virus definition file may take some time, during which several computers may already have been infected. But viruses often show up in emails having similarities in their message part. Through organizational action rules, an email arriving at an employee's computer and showing suspicious patterns (such as certain text in topic or body) could be quarantined into a special folder (e.g. where no attachments could be opened) before a protective virus definition file is anywhere in use for scanning. Organizational action rules are needed because enabling the viewing of the message part of the email at the client is crucial for avoiding false positives; e.g. the network cannot simply discard the messages that might have a virus because that might delete many useful uninfected emails also.

Still even another issue is the protection against junk email. Junk email is flooding the Internet, sometimes with many copies of the same message being sent to a person in an attempt to force the message on people who would not otherwise choose to receive it.

The prior art provides systems that scan all incoming emails except for those coming from white-listed sources and if classified as junk using some predetermined criteria, either destroys the email or tags it with a notification. If the tagging scheme is used, the user must take action to install action rules that stipulate what to do with the email; and to avoid false positives, most often it is desirable to place a tagged email into a special archive folder for later viewing.

What the prior art does not provide in respect to junk email protection is a junk email protection system based on tagging or otherwise indicating emails suspected to be junk email and that, once installed, does not require client end user action in case of updates (except for possible acceptances of the updates). If such a system were integrated into an email client when it is first installed, its administration could be made totally transparent to the client end user.

What is thus also needed is a way of having email clients automatically take into use action rules and folders initiated or modified by a system administrator on some other computer in protection against junk email.

### DISCLOSURE OF THE INVENTION

Accordingly, in a first aspect of the invention, a method is provided, comprising: a step in which an email client obtain from an email server a template folder structure; and a step in which an email client creates a folder structure based on at least a portion of the template folder structure stored on the email server.

In accord with the first aspect of the invention, the method may further comprise: a step in which the email client obtains from the email server template action rules; and a step in which the email client creates action rules based on at least some of the template action rules stored on the email server. Further, the method may also comprise: a step in which the email server receives an email; and a step in which the email server routes the email to one or more email client terminals, which in turn archive the email in a folder of the folder structure based on the template folder structure according to the action rules downloaded from the server.

Also in accord with the first aspect of the invention, the method may further comprise: a step in which the email server receives an email; and a step in which the email server routes all or only part of the email to one or more email client terminals according to settings related to the email client and accessible to the email server.

Also in accord with the first aspect of the invention, the method may further comprise: a step in which the email server receives an email; and a step in which the email server scans the email to determine whether the email is likely a junk email, and if so, adds to the email information indicating the email is likely a junk email.

Also in accord with the first aspect of the invention, the method may further comprise: a step in which the email server receives an email; and a step in which the email server scans the email to determine whether the email is likely a virus-bearing email, and if so, adds to the email information indicating the email likely harbors a virus.

Also in accord with the first aspect of the invention, the email client may subscribe to at least a portion of the template folder structure so as to indicate to the email server what folders are to be downloaded by the email server to the email client, and may subscribe to at least one of the template action rules so as to indicate to the email server what action rules are to be downloaded by the email server to the email client.

In a second aspect of the invention, a computer program product is provided, comprising a computer readable storage structure embodying computer program instructions thereon, by which a computer processor is enabled to perform the email server steps (i.e. the steps indicated as to be performed by the email server) of a method according to the first aspect of the invention.

In a third aspect of the invention, a computer program product is provided, comprising a computer readable storage structure embodying computer program instructions thereon, by which a computer processor is enabled to perform the email server steps of a method according to the first aspect of the invention.

In a fourth aspect of the invention, an email server apparatus is provided, comprising: means by which to create and store a template folder structure based on user inputs; and means by which to create and store template action rules based on user inputs.

In a fifth aspect of the invention, an email client apparatus is provided, comprising: means by which to automatically create action rules based on at least some template action rules stored on an email server; and means by which to automatically create a folder structure based on at least a portion of a template folder structure stored on the email server.

In sixth aspect of the invention, a system is provided, comprising a plurality of email clients and also an email server including an email server apparatus according to the fourth aspect of the invention.

In a seventh aspect of the invention, a system is provided comprising an email server and a plurality of email client terminals, each including an email client apparatus according to the fifth aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of an email server according to the invention.

FIG. 2 is a flowchart illustrating operation of an email system according to the invention.

### DETAILED DESCRIPTION OF THE INVENTION

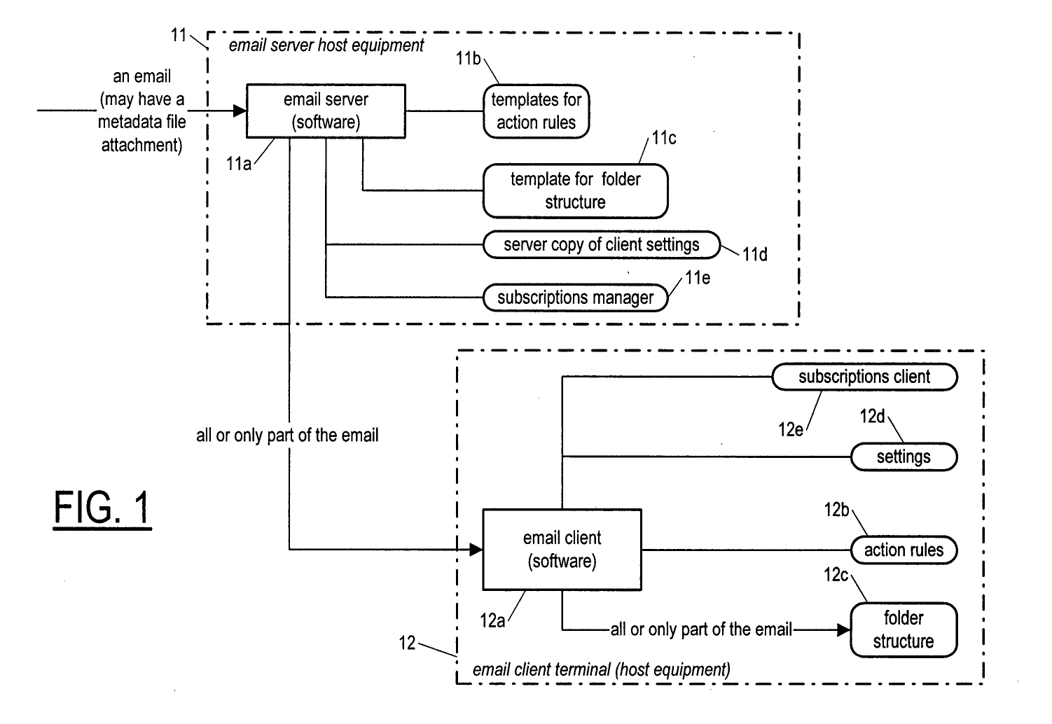

Referring now to FIG. 1, computer server hardware 11 is shown hosting an email server (software) 11a according to the invention, and so hosting a template 11c for a folder structure and also templates 11b for action rules; the email server 11a includes functionality for enabling an email client terminal 12 hosting an email client 12a to copy/download all or part of the template folder structure and so create a folder structure 12c on the email client terminal based on the template folder structure, and also to copy/download one or more of the template action rules and so create action rules 12b based on the templates for action rules stored on the email server terminal. The email client 12a of course includes corresponding functionality.

The template folder structure may be any information in any form indicating a folder structure. For example, it may be an actual set of folders (empty) arranged to form a folder structure, or it may be a description of such a folder structure. The description could be e.g. based on XML (extensible markup language).

The template action rules, similarly, may be any information in any form indicating a action rules.

The email server 11a typically serves several email client terminals 12 and can route email to one or another of the email client terminals.

According to the invention, when an email is received by the email client 12, it is treated according to the action rules 12b on the email client, of which some action rules might have been created based on the templates 11b for action rules downloaded from the email server 11, instructing e.g. the email to be placed into not the inbox (folder) of the email client 12, but instead into another folder in the folder structure 12c. Thus, the templates for action rules 11b—which are used by the email clients, not by the email server—can for example stipulate that if a particular word appears anywhere in the arriving email, then the email client is to archive the email in a particular folder of the folder structure 12c on the email client. The template-based action rules 12b can be considered separate from the email client functionality that uses the rules because from one perspective the rules are “data” used by the functionality, or else can be considered part of the functionality because the rules prescribe the behavior of the email client functionality.

The invention is especially of use in case of an email system for an organization (such as e.g. a business entity). The template folder structure is advantageously one that in some way or another mirrors or is somehow specially adapted to the organization using the email server terminal. The email client terminals 12 are therefore advantageously terminals used by members of the organization (e.g. employees of a business entity). A system administrator advantageously creates the template folder structure 11c using functionality included in the email server 11a or using some related module (not shown) specially adapted to that end and possibly residing in the email client. A system administrator also advantageously creates the templates for the action rules, again using either functionality included as part of the email server 11a or using some specially adapted related module (not shown) that possibly resides in the email client. In this text, a “system administrator” is defined as a person that has the right to do modifications to at least a subset of the template folder structure and to at least a subset of the templates for the action rules. Here a “system administrator” is therefore defined more loosely than in a traditional practical organizational context.

In using the invention, it may be advantageous in some organizations to have local system administrators (e.g. at department, program, project, or team level) create and modify the locally offered folders within a selected folder base (i.e. one or more parts of the template folder structure 11c defined by a system administrator using functionality on the email server 11), each of which might include sub-bases comprising actual archive folders. In practice, the template folder structure could then advantageously mirror the structure of the organization. Since an organization is typically arranged in several different levels, a template folder structure might have e.g. the following levels: company/department/program/project/team/end-user level. The template action rules could be arranged to correspond to the levels, i.e. the action rules can be assigned to apply to only respective levels.

Referring again to FIG. 1, computer server hardware 11 is shown hosting an email server (software) 11a according to the invention, and so hosting a subscriptions manager module 11e that stores the subscriptions of the email users for the templates for the action rules and the folder bases; the subscriptions manager module includes functionality for enabling the email client terminal 12 hosting the email client 12a and using a subscriptions client module 12e to manage the subscriptions of the end user using the client.

According to the invention everyone can subscribe, within the limits of the subscription access rights given by the system administrators, to different templates for folder bases and action rules. This way everyone is offered the same folders, but through subscriptions to different folder bases, everyone can choose which parts of the common folder structure (i.e. the template folder structure) to create on his or her own terminal. Furthermore, the template-based action rules 12b and template-based folder structure 12c can coexist with private action rules 12b and private folders on the equipment 12 hosting the email client 12a. Thus, with the invention, it is possible to arrange that everyone in an organization has a folder structure tailored to suit his/her personal job description, sub-organization and needs, based on the folder bases copied/downloaded from the email server and possibly some limited further personalization done by the user. According to the invention the subscription manager module in the email server propagates, using a standardized protocol, the changes (or the knowledge of the changes) done by system administrators into the templates for action rules and folder structure to the subscriptions client in the email client; it is then up to the settings of the subscriptions client whether these changes are taken into use or not. This way, the clients have the possibility to keep the template-based action rules 12b and the template-based folder structure 12c always up-to-date.

Further according to the invention and still referring to FIG. 1, both the email server 11 and the email client 12 may store client settings—in the server copy of the client settings 11d and in the client copy of the client settings 12d, respectively—to indicate to the email server 11 that only part of an email is to be sent to the client. The settings can be specialized to some kinds of email, e.g. based on the subject or sender, or they can be more general, e.g. no attachments ever. The settings are configured by the email client on the basis of the template-based action rules 12b, the private action rules 12b and the characteristics of both the email client terminal as well as the type of its physical connection to email server. The settings are propagated to the server through “handshaking” (i.e. a standardized protocol) between the client and the server. This way the possible hardware limitations (e.g. limited internal storage size reserved for emails or limited bandwidth available for data transmission between the client and the server) in the email client side can be considered already by the system administrators when creating template-based action rules. Furthermore, when there are updates in the templates for the action rules, it is the subscriptions client that updates the corresponding settings both to the server and the client.

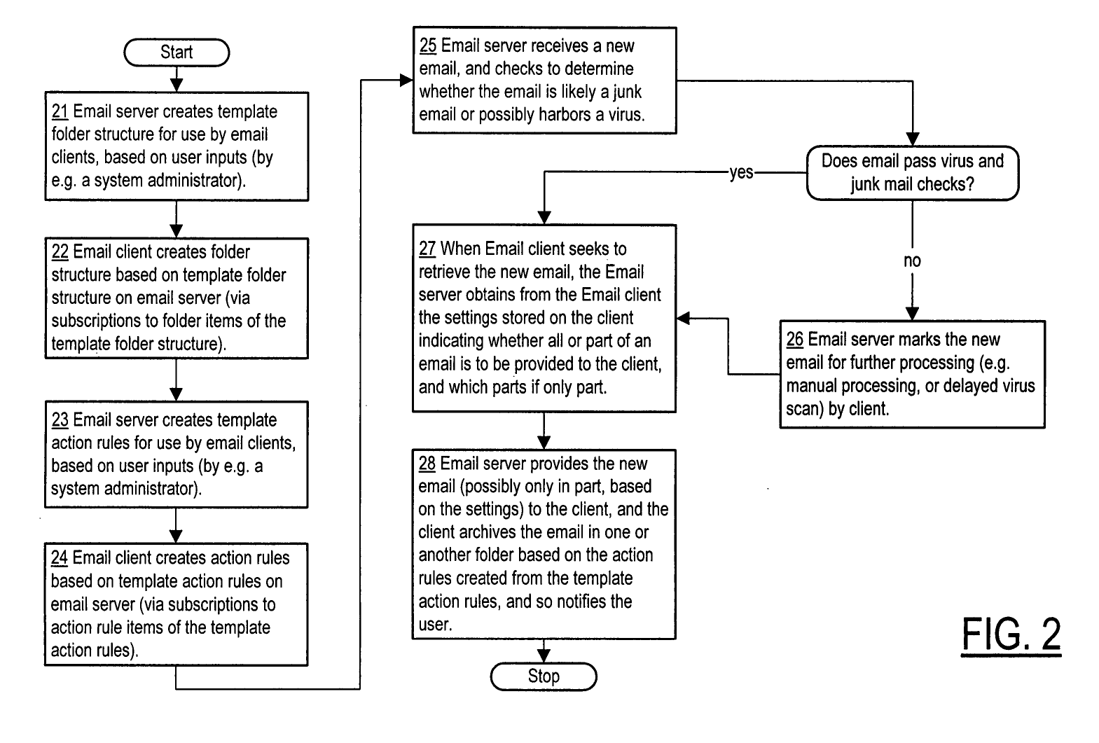

Thus, and now referring also to FIG. 2, the invention provides a method for managing email especially for members of an organization, including a first step 21 in which the email server 11a creates the template folder structure 11c for use by the email client 12a (as well as other email clients, not shown), based on user inputs, typically by the system administrator. (The system administrator creates the folder subscriptions items so as to be available to client users to subscribe to. The subscription client then subscribes to the folder items.) In a next step 22, the email client 12a creates the folder structure 12c at least partially based on the subscribed template folder structure 11c. In a next step 23, the email server 11a also creates template action rules for use by the email client 12a (and others), based on user inputs (by e.g. a system administrator). (The system administrator creates the action rule subscriptions items so as to be available to client users to subscribe to. The subscription client then subscribes to the action rule items.) In a next step 24, the email client 12a creates the (data store of) action rules 12b derived at least partially from the subscribed template action rules 11b, based on user inputs (by the user of the email client). (The client constructs the settings and propagates these to the server.)

Now, when a new email arrives for the email client 12a, in a next step 25 the email server 11a receives the new email, and checks (possibly by consulting an external module produced by an expert vendor) to determine whether it is likely to be a junk email or whether it possibly harbors a virus. If the new email is determined to be either junk email or to possibly harbor a virus, then in a step 26 it is marked so as to be appropriately handled by the email client. In a next step 27, when the email client 12a seeks to retrieve the new email or (depending on the email protocols and procedures used) when the email server seeks to upload the new email to the client, the email server 11a refers to the server copy of the client settings 11d (possibly right after obtaining them from the email client) that indicate whether all or part of an email is to be provided to the client, and which parts in case only part is to be provided. (Whether the server sends all or only part of an email to a client depends of course on who the client is, and what is to be done is known to the server via the settings for the client.)

In a next step 28, the email server provides the new email (possibly only in part, based on the settings) to the client, and the client archives the email in one or another folder based on the action rules created from the template action rules, and so notifies the user.

If, the email does not pass the virus and junk mail checks, then in the step 26 the email server tags the email so that the clients will recognize it as junk or to contain a possible virus on the basis of the templates for the action rules downloaded from the server. In this case, it might be advantageous for the organization to allow also third parties, i.e. external expert companies, to provide system administration services in the creation and maintenance of action rules templates for virus or junk email protection. An action rule written by a system administrator (possibly from an external expert company) could then stipulate e.g. that an email arriving at an employee's computer that has been tagged by an external module at the server side to show suspicious patterns (such as certain text in topic or body) could be placed or quarantined into a special folder (e.g. where no attachments could be opened). Thus, according to the invention, and now purely concentrating on virus protection, in addition to reacting to emails that fail the virus scan on the basis of a protective virus definition file, the external virus-protection module on the server side would tag the emails that pass that scan but are suspected to contain a virus on some other grounds (e.g. known patterns in the message part of the email) so that those emails can be recognized by email clients using the action rule templates. The role of the system administrator would then be extended to keep the external virus protection module up-to-date of the patterns shown in the message part of the email by the most recent viruses, before those patterns have been incorporated into any protective virus definitions files.

In an illustrative embodiment, the email clients obtain the template folder structure and template action rules, and the email server obtains the subscriptions and setting (and related parameters) using a (new, not herein defined) standardized protocol—defined e.g. in a series of RFCs (Request for Comments), published under general direction of the IAB (the Internet Architecture Board). There could be a new IP (Internet protocol) network server functionality that would manage the template action rules and the template folder structure and the subscriptions and setting; the new IP network server functionality could be implemented as part of the existing email servers or as a stand-alone server.

The invention has been described above in terms (primarily) of the steps of a method (FIG. 2). The invention also comprehends a corresponding apparatus, i.e. an apparatus for performing the above-described steps. Thus, for each step described above, there can be a corresponding module of the corresponding apparatus, although it is also possible for the functionality for performing more than one of the above-described steps to be incorporated into a single module, e.g. the email server 11a. The module or modules may be implemented as hardware, or may be implemented as software or firmware for execution by a processor. In particular, in the case of firmware or software, the invention is provided as a computer program product including a computer readable storage structure embodying computer program code with instructions corresponding to the described method—i.e. the software or firmware—thereon for execution by a computer processor. There would be a computer program by which an email server operates according to the invention, and a computer program product by which an email client operates according to the invention.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which an email client obtains from an email server a template folder structure; and
a step in which the email client creates a folder structure based on at least a portion of the template folder structure stored on the email server.

2. A method as in claim 1, further comprising:
a step in which the email client obtains from the email server template action rules; and
a step in which the email client creates action rules based on at least some of the template action rules stored on the email server.

3. A method as in claim 2, further comprising:
a step in which the email server receives an email; and
a step in which the email server routes the email to one or more email client terminals, which in turn archive the email in a folder of the folder structure based on the template folder structure according to the action rules downloaded from the server.

4. A method as in claim 1, further comprising:
a step in which the email server receives an email; and
a step in which the email server routes all or only part of the email to one or more email client terminals according to settings for the email client terminals accessible to the email server.

5. A method as in claim 1, further comprising:
a step in which the email server receives an email; and
a step in which the email server scans the email to determine whether the email is likely a junk email, and if so, adds to the email information indicating the email is likely a junk email.

6. A method as in claim 1, further comprising:
a step in which the email server receives an email; and
a step in which the email server scans the email to determine whether the email is likely a virus-bearing email, and if so, adds to the email information indicating the email likely harbors a virus.

7. A method as in claim 1, further comprising a step in which the email client subscribes to at least a portion of the template folder structure so as to indicate to the email server what folders are to be downloaded by the email server to the email client.

8. A method as in claim 1, further comprising a step in which the email client subscribes to at least one of the template action rules so as to indicate to the email server what action rules are to be downloaded by the email server to the email client.

9. A computer program product, comprising a computer readable storage structure embodying computer program instructions thereon, by which a computer processor hosted by an email client is enabled to perform the email client steps of the method of claim 1.

10. A computer program product, comprising a computer readable storage structure embodying computer program instructions thereon, by which a computer processor hosted by an email client is enabled to perform the email client steps of the method of claim 2.

11. A computer program product, comprising a computer readable storage structure embodying computer program instructions thereon, by which a computer processor hosted by an email server is enabled to perform the email server steps of the method of claim 3.

12. A computer program product, comprising a computer readable storage structure embodying computer program instructions thereon, by which a computer processor hosted by an email server is enabled to perform the email server steps of the method of claim 4.

13. An email server apparatus, comprising:
means by which to create and store a template folder structure based on user inputs; and
means by which to create and store template action rules based on user inputs.

14. A system, comprising an email server including an email server apparatus as in claim 13, and also comprising a plurality of email client terminals.

15. An email client apparatus, comprising:
means by which to automatically create action rules based on at least some template action rules stored on an email server; and
means by which to automatically create a folder structure based on at least a portion of a template folder structure stored on the email server.

16. A system, comprising a plurality of email client terminals each including an email client apparatus as in claim 14, and an email server.
